(19) United States
(12) Patent Application Publication
(10) Pub. No.: US 2025/0276676 A1
(43) Pub. Date: Sep. 4, 2025

(54) METHOD FOR OPERATING A MOTOR VEHICLE, COMPUTER PROGRAM PRODUCT, STORAGE MEDIUM, COMPUTER DEVICE

(71) Applicant: Robert Bosch GmbH, Stuttgart (DE)

(72) Inventors: Andreas Zoebele, Markgroeningen (DE); Jan Scheuing, Vellberg (DE); Jan Becker, Backnang (DE); Markus Beisswenger, Schwaebisch Hall (DE)

(21) Appl. No.: 19/065,388

(22) Filed: Feb. 27, 2025

(30) Foreign Application Priority Data
Feb. 29, 2024 (DE) 10 2024 201 864.3

(51) Int. Cl. B60T 8/88; B60T 8/32

(52) U.S. Cl. CPC B60T 8/885; B60T 8/321; B60T 2250/04

(57) ABSTRACT

A method for operating a motor vehicle. The motor vehicle includes at least one axle having a wheel, and wherein the wheel is assigned a wheel braking device having a controllable actuator, in particular electric machine. The actuator is controlled, depending on a braking request, selectively with a continuous or a cyclic control of an operating point of the actuator for implementing a requested braking force and/or a requested braking torque.

### FIELD

The present invention relates to a method for operating a motor vehicle, wherein the motor vehicle comprises at least one axle having a wheel, and wherein the wheel is assigned a wheel braking device having a controllable actuator, in particular electric machine.

Furthermore, the present invention relates to a computer program product which performs the above method if the computer program product is executed on a computer device. Furthermore, the present invention relates to a machine-readable storage medium having such a computer program product and to a computer device that is specifically configured to execute the computer program product or to carry out the above-mentioned method.

### BACKGROUND INFORMATION

All modern motor vehicles use braking force optimization methods on the wheel. These methods are required for the anti-lock braking system (ABS), which is mandatory in most markets. Here, the aim of the ABS is to regulate the longitudinal force on the wheel as optimally as possible, without causing the wheel to lock, while at the same time ensuring steerability. It is conventional to carry out either a continuous or a cyclic control of an operating point of the actuator assigned to the corresponding wheel braking device, in order to fulfill a corresponding braking request.

### SUMMARY

According to the present invention, a method is provided in which the actuator is controlled, depending on a braking request, selectively with a continuous or a cyclic control of an operating point of the actuator for implementing a requested braking force and/or a requested braking torque. According to an example embodiment of the present invention, it is provided that a decision is made depending on the situation whether the operating point is controlled continuously or cyclically. Depending on the situation, either continuous or cyclic control is particularly advantageous so that the method according to the present invention optimizes the overall braking effect within the framework of an anti-lock braking system. With cyclic control, for example, an increase in braking force or braking torque on the particular wheel causes the maximum friction coefficient of the tire, which results in particular from a correspondingly known friction coefficient-wheel slip characteristic curve, to be exceeded so that the wheel is now in an unstable region. Due to the reduction in braking force or braking torque, the wheel is accelerated back into a stable region. As soon as the wheel acceleration is sufficiently high, the braking force or braking torque increases again and cyclic control is repeated. With continuous control, for example, the attempt is made to stay as long as possible and as close as possible to, but still below, the maximum friction coefficient without exceeding it. Both cyclic and continuous control have different strengths and weaknesses. Cyclic control has the disadvantage that the wheel braking force or wheel braking torque, after exceeding the maximum friction coefficient and after the subsequent necessary reduction in braking force or braking torque, remains in a non-optimally braked range below the maximum friction coefficient for a certain time until the wheel is stabilized. During this time, the wheel is not braked optimally. An advantage of cyclic control is that, when environmental conditions change, which affect the corresponding characteristic curve, for example, and/or there is a change in the braking coefficient (Cp value) or the load, the maximum friction coefficient is always exceeded and robust optimization of the braking effect thus takes place. A further advantage is that cyclic control can be implemented with few sensors (for example, four wheel speed sensors (WSS)), which results in an advantageously high availability (for example, fallback level). Continuous control offers the advantage that braking force or braking torque are always kept close to the optimum for a long time so that, on average, very high braking forces or braking torques arise. In addition, the lower modulation of braking force or braking torque, for example in a hydraulic braking system, is advantageous in terms of driving comfort. Disadvantages of continuous control are, on the one hand, relatively high requirements for vehicle velocity estimation in order to determine the brake slip, because this requires a relatively high sensor effort and, in this respect, also results in low availability in the event of sensor failures. On the other hand, knowledge of the characteristic curve mentioned is necessary in order to ascertain an optimal target slip. The present invention is therefore based on the idea of optimally applying or combining these control methods for the particular driving situation, in particular alternating or switching between them depending on the situation. The present invention combines the strengths of the two control methods in such a way that the weaknesses are largely compensated.

According to a preferred development of the present invention, it is provided that continuous control is carried out only within a linear section of a friction coefficient-wheel slip characteristic curve, and that cyclic control is carried out within the linear section or within a non-linear section of the friction coefficient-wheel slip characteristic curve. When the corresponding characteristic curve is used in this way, the advantages of the method according to the present invention are particularly pronounced. The non-linear region is defined in particular in such a way that it begins close to a maximum value of the friction coefficient and extends up to a maximum value of the wheel slip. As already described above, with continuous control, the maximum value of the friction coefficient is always fallen below, whereas, with cyclic control, the maximum value of the friction coefficient is exceeded at least for a short time and the operating point is then shifted back into the linear region. The particular operating point lies either on or below the characteristic curve in the particular region.

According to an example embodiment of the present invention, it is particularly preferably provided that a type of braking request is determined depending on at least one parameter, in particular a plurality of parameters, characterizing a deceleration and/or a sensor status, and the actuator is controlled depending on the type of braking request. The selection of the corresponding control method, i.e., whether control is performed cyclically or continuously, thus preferably arises from the type of the braking request, in particular the level of the requested deceleration, on the basis of which it can be determined, for example, whether a comfort braking or a panic braking is being requested, the availability of a corresponding sensor, or whether the corresponding control is particularly suitable for supporting the ascertainment of a vehicle state-related value, for example the actual driving velocity of the motor vehicle, a friction coefficient, and/or a target value for a wheel slip. As a result, it is advantageously ensured that the optimal control strategy for the situation is selected.

According to a preferred development of the present invention, it is provided that, if a braking request within a specified deceleration range is recognized, continuous control is carried out. The specified deceleration range is selected in particular in such a way that it is in the range of comfort braking, i.e., at relatively low decelerations, but at least at a distance from panic braking. In the case of pure comfort braking, cyclic control is preferably completely dispensed with in order to generate more driving comfort. In such cases, due to the selection of continuous control, an advantageously improved driving comfort arises because continuous control is less noticeable for the driver than cyclic control, for example due to smaller strokes in wheel pressure modulation, less pedal feedback, improved NVH behavior, and lower volume consumption. The deceleration range then corresponds in particular to one of the above-mentioned parameters characterizing the deceleration.

According to an example embodiment of the present invention, it is particularly preferably provided that, if a braking request for a maximum deceleration and/or an exceeding of a specified threshold value for a friction coefficient during a braking request is recognized, cyclic control is carried out. In the case of such a braking request, panic braking is in particular to be assumed, for which it is particularly important to achieve the shortest possible braking distance. In contrast, the above-mentioned driving comfort improvements as in the case of comfort braking are less relevant. If, for example, the friction coefficient-wheel slip characteristic curve mentioned is unknown, it may happen that, in the case of continuous control during such ABS braking, the characteristic curve must first be learned, which takes a corresponding amount of time and, for example, in the case of panic braking, initially leads to an extended braking distance until the correct target slip is found. Accordingly, it is then advantageous to carry out cyclic control on at least one wheel at least at the beginning of the corresponding braking in order to achieve maximum braking effect. This results in a plurality of advantages; on the one hand, when the characteristic curve is unknown, the maximum friction coefficient is safely exceeded within a short time, and the cyclic exceeding of the maximum can be used for learning the characteristic curve; and, on the other hand, advantageously determining the operating point of a corresponding brake pressure valve based on knowledge of the maximum is particularly simply because the relevant state variables are known and can be specifically calculated in isolation. The maximum deceleration and/or threshold value then correspond in particular analogously in each case to one of the above-mentioned parameters characterizing the deceleration.

According to a preferred development of the present invention, it is provided that, if a request for ascertaining an actual driving velocity of the motor vehicle, a friction coefficient, and/or a target value for wheel slip is recognized during a braking request, cyclic control is carried out. As already mentioned above, cyclic control is particularly advantageous suitable for ascertaining the actual driving velocity so that improved vehicle velocity support is achieved by at least briefly carrying out cyclic control on at least one wheel. Due to the reduction in braking force or braking torque on the wheel after exceeding the maximum, as described above, the wheel is re-accelerated up to the actual vehicle velocity. On the one hand, this process within a cyclicity is advantageous, as it occurs faster than conventional adjustment phases of continuous controls, where the wheel must be deliberately under-braked, and on the other hand, the wheel is simultaneously over-braked and there is less loss of braking power. The corresponding request for ascertaining the actual driving velocity of the motor vehicle, the friction coefficient, and/or the target value for the wheel slip is also in particular one of the parameters mentioned above, which characterize a sensor status here, for supporting the ascertainment of a sensor value because, due to the control, support of a corresponding value can be achieved or an otherwise ascertained value, in particular a measured or estimated value, can be validated and/or adjusted.

According to an example embodiment of the present invention, it is particularly preferably provided that, if a failure of a sensor system, assigned to the motor vehicle, in particular an inertial sensor system, is recognized during a braking request, cyclic control is carried out. As a result, the availability of the corresponding control is increased in a particularly advantageous way. Depending on the sensor system available, the control preferably contains fewer or more cyclic components. If the sensor system only fails partially, for example, the control is switched to cyclic control for at least a specified period of time or alternates between continuous and cyclic control at specified intervals. For example, in the event of a complete failure of the inertial sensor system, only cyclic control is carried out; in particular, the control is switched from continuous to cyclic control. The failure of the sensor system is in particular detected as the particular sensor status of the corresponding sensors, wherein this sensor status accordingly analogously represents one of the above-mentioned parameters in each case.

According to a preferred development of the present invention, it is provided that, depending on the braking request, the control is switched from continuous control to cyclic control at least for a specified period of time. As a result, the robustness of the method is increased in a particularly advantageous way. For example, such switching, as described above, occurs in the event of only partial failure of a sensor system, and/or for carrying out driving velocity support, ascertainment of a friction coefficient, and/or adjustment of a target value for a wheel slip.

A computer program product according to the present invention for execution on a computer device performs the method according to the present invention when used as intended. This results in the advantages already mentioned.

A machine-readable storage medium according to the present invention includes the computer program product according to the present invention stored thereon.

A computer device according to the present invention is specifically configured to execute the computer program product according to the present invention or to carry out the method according to the present invention. This also results in the advantages already mentioned above. Preferably, the computer device is a control device assigned to a motor vehicle, in particular arranged in the motor vehicle.

For example, a corresponding motor vehicle comprises at least one axle having at least one wheel, wherein a wheel braking device having a controllable actuator, in particular electric machine, is assigned to the wheel, and is characterized by at least one computer device according to the present invention designed as a control device. This results in the advantages already mentioned. Particularly preferably, the motor vehicle comprises at least a first and a second wheel on the axle, wherein the first wheel, which is assigned in particular to a left side of the motor vehicle, is assigned a first wheel braking device having a controllable first actuator, in particular electric machine, and wherein the second wheel, which is assigned in particular to a right side of the motor vehicle, is assigned a second wheel braking device having a controllable second actuator, in particular electric machine. This also results in the advantages already mentioned.

Further preferred features and combinations of features of the present invention result from what is disclosed herein. The present invention is explained in more detail below with reference to the figures.

### BRIEF DESCRIPTION OF THE DRAWINGS

FIG. 1 shows an advantageous example method for operating a motor vehicle, according to the present invention.

FIG. 2A shows diagrams of a cyclic control for the method of the present invention.

FIG. 2B shows diagrams of a continuous control for the method of the present invention.

FIG. 3 shows diagrams of a combined control when carrying out the method according to an example embodiment of the present invention.

FIG. 4 shows a diagram of relevant slip values.

### DETAILED DESCRIPTION OF EXAMPLE EMBODIMENTS

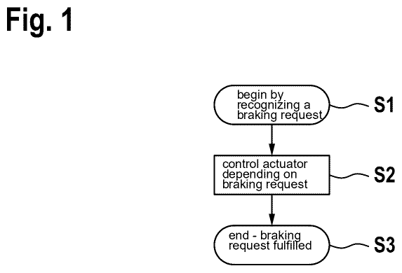

An advantageous method for operating a motor vehicle is described below with reference to FIG. 1. FIG. 1 shows the method using a flow chart. In particular, the method ensures that a braking effect of the motor vehicle is optimized within the framework of anti-lock braking control.

The motor vehicle comprises at least one axle having a wheel, wherein the wheel is assigned a wheel braking device having a controllable actuator, in particular electric machine. The method according to the present invention relates to a control at the wheel level for the actuator.

In a step S1, the method begins by recognizing a braking request, for the fulfillment of which the actuator must be controlled accordingly. For this purpose, in principle, the actuator can be controlled with a continuous or cyclic control of an operating point of the actuator in order to implement a braking force requested according to the braking request and/or a braking torque requested according to the braking request.

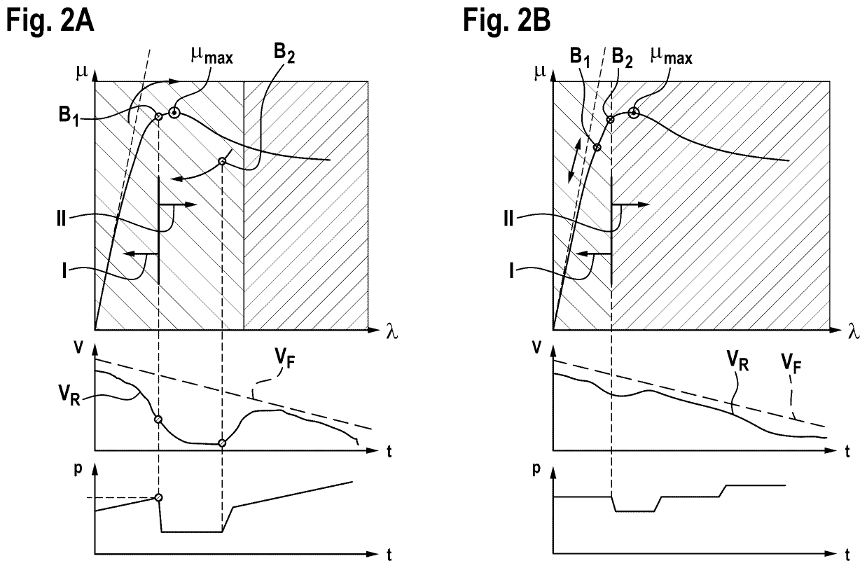

The cyclic control that can be used within the framework of the method is shown in FIG. 2A in three diagrams located one above the other. Analogously, the continuous control that can also be used is shown in FIG. 2B in three further diagrams located one above the other. In the topmost of the three diagrams, a friction coefficient-wheel slip characteristic curve in which the friction coefficient μ is plotted over the wheel slip λ is shown in each case.

In each case, the characteristic curve comprises a first linear section I and a second non-linear section II, wherein the non-linear section II is close to a maximum value of the friction coefficient μₘₐₓ and extends to a maximum value of the wheel slip λ.

With cyclic control, due to an increase in braking force or braking torque, a maximum value of the friction coefficient μₘₐₓ of the tire, which results from the friction coefficient-wheel slip characteristic curve, is exceeded at the particular wheel. By way of example, a first operating point B₁ of the actuator, located on the characteristic curve before the exceeding, and a second operating point B₂, located below the characteristic curve after the exceeding, are shown, with the second point lying within the nonlinear section II, below the characteristic curve, where the wheel is now in an unstable region.

Due to a reduction in braking force or braking torque, the wheel is accelerated back into a stable region, in particular back to the operating point B₁, which lies within the linear section I of the characteristic curve. As soon as the wheel acceleration is sufficiently high, an increase in braking force or braking torque is carried out again, and the cyclic control is repeated, as indicated by corresponding arrows.

In contrast, with continuous control, the aim is to stay as long as possible and as close as possible to, but still below, the maximum value of the friction coefficient μₘₐₓ without exceeding it. By way of example, a first operating point B₁ of the actuator, located on the characteristic curve, and a second operating point B₂, located on the characteristic curve, are shown, both of which lie within the linear section I, where the wheel is in a stable region. As indicated by a corresponding double arrow, alternating always occurs between two operating points that lie before the maximum value.

Continuous control is thus carried out only within the linear section I, and cyclic control within the linear section I or within the non-linear section II.

In the second, middle of the three diagrams, a corresponding temporal progression over time t of velocities v is shown in each case, specifically the vehicle velocity v_{F} and the wheel velocity v_{R}. It can be seen that, with cyclic control, the wheel velocity v_{R} deviates relatively far from the vehicle velocity v_{F} at the two operating points B₁, B₂, whereas, with continuous control, the wheel velocity v_{R} has a much smaller deviation from the vehicle velocity v_{F} and fluctuates less.

In the third, bottom diagram, a corresponding temporal progression over time t of the corresponding braking pressure p at the wheel is shown in each case, where, in the case of cyclic control, it can be seen that the braking pressure p reaches a maximum, in particular locking pressure, after an initial increase, then drops again due to the above-described reduction, and rises again in the next cycle, whereas, in the case of continuous control, the braking pressure p only changes in small increments.

As already described in detail above, each of the two controls has its advantages and disadvantages. The method according to the present invention is therefore intended to make the best possible use of the corresponding advantages and to avoid the disadvantages as far as possible. For this purpose, the actuator is controlled in a step S2, depending on the braking request, selectively with continuous or cyclic control. Preferably, a type of braking request is determined depending on at least one parameter, in particular a plurality of parameters, characterizing a deceleration and/or a sensor status, and the actuator is controlled depending on the type of braking request.

Continuous control is carried out if a braking request within a specified deceleration range is recognized as a parameter. Cyclic control is carried out if a braking request for a maximum deceleration and/or an exceeding of a specified threshold value for a friction coefficient during a braking request, a request to ascertain an actual driving velocity of the motor vehicle, a friction coefficient, and/or a target value for a wheel slip, and/or a failure of a sensor system, assigned to the motor vehicle, in particular an inertial sensor system, during a braking request is recognized as a corresponding parameter. The method then ends in each case with a step S3 when the braking request is fulfilled.

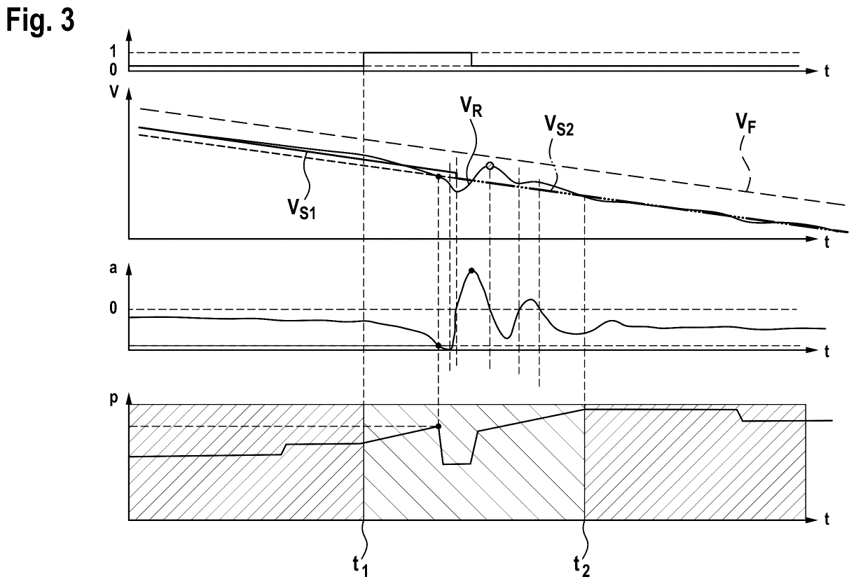

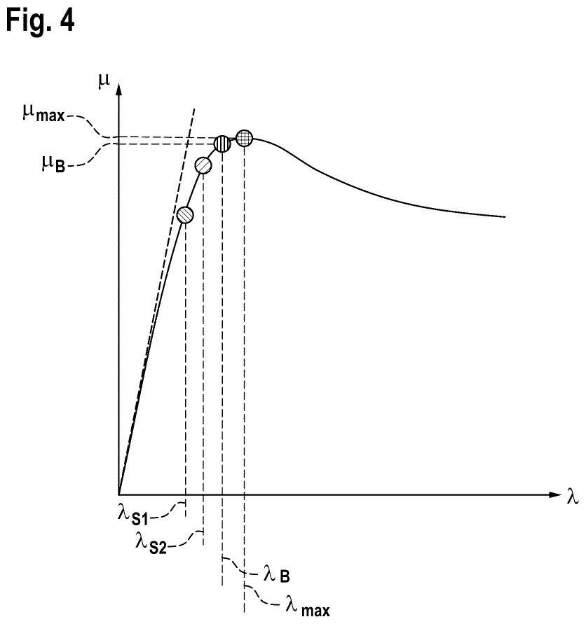

Preferably, depending on the braking request, the control is switched from continuous control to cyclic control for at least a specified period of time. Such an example is also shown in FIGS. 3 and 4. FIG. 3 shows four diagrams located one above the other of a combined control during the carrying out of the method, and FIG. 4 shows a diagram of relevant friction coefficients and slip values.

Continuous control must be tailored to a specific tire or is based on a specific tire characteristic, which is specified by the friction coefficient-wheel slip characteristic curve mentioned above. If the tire, the condition of the tire, and/or the tire temperature change, deviations in the target slip may arise. Methods for adjusting the target slip require time and only take place during ABS braking. In order to improve this, in the exemplary embodiment shown, an advantageously faster target slip adjustment and state estimation are achieved during a continuous control by switching to at least one cycle of a cyclic control.

The wheel is initially in continuous control. In the topmost of the four diagrams, a binary temporal progression of a switch signal for switching to cyclic control is plotted. This is initially logic zero. In the second of the four diagrams, a temporal progression of velocities is plotted again, in this case again the vehicle velocity v_{F}, the actual value of the wheel velocity v_{R}, along with a first target value of the wheel velocity v_{S1}, and a second target value of the wheel velocity V_{S2}.

A first target value of the wheel slip λ_{S1} initially results from the mathematical relationship

$${λ}_{s} = \frac{{v}_{F} - {v}_{S 1}}{{v}_{F}}$$

A switch to cyclic control is now carried out via the switch signal, which is now logic 1. As described above, the switch signal is triggered by a parameter relating to a braking request, for example a friction coefficient and/or slip, in the present case with the aim of a target slip adjustment, in particular by a request for ascertaining the actual friction coefficient and/or a target slip. The corresponding switch signal can additionally or alternatively be triggered via one of the additional parameters explicitly mentioned above, i.e., in particular if a braking request for a maximum deceleration and/or an exceeding of a specified threshold value for a friction coefficient during a braking request, a request for ascertaining an actual driving velocity of the motor vehicle and/or an at least partial failure of a sensor system, assigned to the motor vehicle, during a braking request is recognized as a parameter.

Due to the cyclic control, the braking force or braking torque is increased until the maximum friction coefficient is exceeded. Given that the basic mechanism has already been described above, it will not be repeated here.

However, in FIG. 3, in the third of the four diagrams, it can be seen from the temporal progression of the wheel acceleration a how cyclic control is carried out. In the fourth, lower of the four diagrams, the temporal progression of the corresponding brake pressure p at the wheel is also shown.

As can be easily seen by comparing with FIGS. 2A and 2B, continuous control is carried out up to a first point in time t₁, cyclic control is carried out between the first point in time t₁ and a second point in time t₂, and continuous control is again carried out after the second point in time t₂.

The characteristic curve and target slip are adjusted accordingly. The wheel pressure at the point in time of reduction corresponds to the force or the torque at which the wheel becomes unstable and tends to lock, i.e., analogously to FIG. 2A, the first maximum within cyclic control. When the normal force is known, this corresponding wheel pressure can be used to approximate the maximum value of the wheel slip λₘₐₓ, which is plotted in FIG. 4 on the corresponding friction coefficient-wheel slip characteristic curve and assigned to the corresponding maximum value of the friction coefficient μₘₐₓ Via the characteristic curve.

If the wheel velocity at the corresponding point in time is lower than the first target value of the wheel velocity V_{S1}, which is the case here, it can be assumed that the target value of the wheel velocity v_{S1} is too high and that the corresponding first target value of the wheel slip λ_{S1}, which is also plotted in FIG. 4, is too low. Accordingly, the second, lower target value of the wheel velocity v_{S2}, and thus a second, higher target value of the wheel slip λ_{S2}, is now specified.

However, since the wheel tends to lock at the considered velocity, a safety offset is preferably added in order to keep the wheel within the stable region of the characteristic curve during continuous control so that the second target value of the wheel velocity v_{S2} is increased by the safety offset. Accordingly, the second target value of the wheel slip λ_{S2} lies on the curve slightly below a locked-wheel slip λ_{B} and its associated locked-wheel friction coefficient μ_{B}. The corresponding locked-wheel slip λ_{B} can again be used to approximate the maximum value of the wheel slip λₘₐₓ, and the characteristic curve can be adjusted accordingly by means of the locked-wheel slip λ_{B} and the locked-wheel friction coefficient μ_{B}.

After the pressure reduction, the wheel is re-accelerated, and the friction coefficient of the road is now ascertained via the maximum of the acceleration a. For small re-accelerations, the friction coefficient is small; for large re-accelerations, the friction coefficient is large.

After re-acceleration, the wheel velocity v_{R} reaches a maximum, which represents the actual vehicle velocity so that it is preferably also ascertained. This type of reference support occurs faster via the cyclicity than other individual wheel under-braking used in continuous controllers, as described above.

The transition from cyclic to continuous control takes place at the point in time t₂, as soon as the current wheel velocity drops below the adjusted target wheel velocity, i.e., the actual value of the wheel velocity v_{R} falls below the second target value of the wheel velocity v_{S2}.

1-11. (canceled)

12. A method for operating a motor vehicle, wherein the motor vehicle includes at least one axle having a wheel, and wherein the wheel is assigned a wheel braking device having a controllable actuator including an electric machine, the method comprising:
controlling the actuator, depending on a braking request, selectively with a continuous control or a cyclic control of an operating point of the actuator for implementing a requested braking force and/or a requested braking torque.

13. The method according to claim 12, wherein the continuous control is carried out only within a linear section of a friction coefficient-wheel slip characteristic curve, and cyclic control is carried out within the linear section or within a non-linear section of the friction coefficient-wheel slip characteristic curve.

14. The method according to claim 12, wherein a type of braking request is determined depending on at least one parameter, characterizing a deceleration and/or a sensor status, and the actuator is controlled depending on the type of braking request.

15. The method according to claim 12, wherein when a braking request within a specified deceleration range is recognized, continuous control is carried out.

16. The method according to claim 12, wherein when a braking request for a maximum deceleration and/or an exceeding of a specified threshold value for a friction coefficient during a braking request is recognized, cyclic control is carried out.

17. The method according to claim 12, wherein when a request for ascertaining an actual driving velocity of the motor vehicle, a friction coefficient, and/or a target value for wheel slip is recognized during a braking request, cyclic control is carried out.

18. The method according to claim 12, wherein when a failure of an inertial sensor system, assigned to the motor vehicle, is recognized during a braking request, cyclic control is carried out.

19. The method according to claim 12, wherein depending on the braking request, the control is switched from continuous control to cyclic control for at least a specified period of time.

20. A non-transitory machine-readable storage medium on which is stored a computer program for operating a motor vehicle, wherein the motor vehicle includes at least one axle having a wheel, and wherein the wheel is assigned a wheel braking device having a controllable actuator including an electric machine, the computer program, when executed by a computer device, causing the computer device to perform the following steps:
controlling the actuator, depending on a braking request, selectively with a continuous control or a cyclic control of an operating point of the actuator for implementing a requested braking force and/or a requested braking torque.

21. A computer device, comprising:
an electronic control device for a motor vehicle, the electronic control device configured to for operate the motor vehicle, wherein the motor vehicle includes at least one axle having a wheel, and wherein the wheel is assigned a wheel braking device having a controllable actuator including an electric machine, the electronic control device configured to:
control the actuator, depending on a braking request, selectively with a continuous control or a cyclic control of an operating point of the actuator for implementing a requested braking force and/or a requested braking torque.
